(19) United States
(12) Patent Application Publication
(10) Pub. No.: US 2026/0166716 A1
(43) Pub. Date: Jun. 18, 2026

(54) AUTONOMOUS DRIVING ROBOT, CLOUD APPARATUS, AND LOCATION CORRECTION METHOD

(71) Applicant: LG ELECTRONICS INC., Seoul (KR)

(72) Inventors: Sewan GU, Seoul (KR); Seungmin BAEK, Seoul (KR); Seungwon LEE, Seoul (KR); Wonhong JEONG, Seoul (KR); Youngjae KIM, Seoul (KR)

(73) Assignee: LG ELECTRONICS INC., Seoul (KR)

(21) Appl. No.: 18/718,718

(22) PCT Filed: Mar. 10, 2022
(86) PCT No.: PCT/KR2022/003328

§ 371 Date: Jun. 11, 2024

(30) Foreign Application Priority Data
Dec. 16, 2021 (KR) 10-2021-0180366

(51) Int. Cl. G05D 1/00; B25J 9/00

(52) U.S. Cl. CPC B25J 9/0087

(57) ABSTRACT

An autonomous mobile robot comprises a communicator, at least one second sensor, and a processor. The processor receives a relative position information of the autonomous mobile robot that is driving autonomously, acquires an absolute position value of the autonomous mobile robot based on the relative position information of the autonomous mobile robot, and corrects the current position value of the autonomous mobile robot based on the absolute position value of the autonomous mobile robot. The relative position information of the autonomous mobile robot may be acquired by each of a plurality of first sensors installed in an indoor area of the building, and the current position value of the autonomous mobile robot may be acquired by at least one second sensor.

### TECHNICAL FIELD

The embodiment relates to an autonomous mobile robot, cloud device, and position correction method.

### BACKGROUND ART

A robot is a machine that automatically processes or operates a given task based on its own capabilities, and its application fields are generally classified into various fields such as industrial, medical, space, and undersea applications. Recently, the number of communication robots that can communicate or interact with humans through voice or gestures is increasing.

These communication robots may include various types of robots, such as guide robots that are placed in specific locations and provide users with various information, or home robots that are installed at home. Additionally, the communication robot may include an educational robot that guides or assists the learner's learning through interaction with the learner.

These robots can perform a variety of functions not only at home but also in public places such as airports.

Meanwhile, by combining autonomous driving technology, robots can drive autonomously without operator intervention. A robot capable of autonomous driving like this is called an autonomous mobile robot.

In order to autonomously drive to a desired location or destination, an autonomous mobile robot must accurately know its current location.

However, autonomous mobile robots only drive autonomously believing that their current location is accurate, and it is unknown whether their current location is accurate. Additionally, in reality, position errors occur in the current position recognized by the autonomous mobile robot due to various environments or malfunctions of various sensors provided in the autonomous mobile robot during autonomous driving. When these position errors accumulated, problems arise in the autonomous driving of autonomous mobile robots. In other words, when the autonomous mobile robot moves beyond the intended destination, incorrect information or incorrect actions are performed, or the autonomous mobile robot itself is put into a difficult situation. For example, if the autonomous mobile robot deviates from its destination and arrives at a swimming pool, the autonomous mobile robot falls into the swimming pool. For example, if the autonomous mobile robot deviates from the desired destination and the destination is not on the table, the cup released from the autonomous mobile robot falls to the ground and breaks.

### DISCLOSURE

### Technical Problem

The embodiment aims to solve the above-mentioned problems and another problems.

Another purpose of the embodiment is to provide an autonomous mobile robot, cloud device, and position correction method that can always maintain an accurate current position.

Another purpose of the embodiment is to provide an autonomous mobile robot, cloud device, and position correction method that can increase the accuracy and precision of autonomous driving through correction of the current position.

The technical problems of the embodiments are not limited to those described in this item and include those that can be understood through the description of the invention.

### Technical Solution

According to a first aspect of the embodiment to achieve the above or another objects, an autonomous mobile robot that autonomously drives in an indoor area of a building includes: a communicator; at least one second sensor; and a processor. The building comprises a plurality of first sensors installed in the indoor area. The processor receives relative position information of the autonomous mobile robot that is autonomously driving through the communicator, and the relative position information of the autonomous mobile robot is acquired by each of the plurality of first sensors, and acquire the absolute position value of the autonomous mobile robot based on the relative position information of the autonomous mobile robot, correct the current position value of the autonomous mobile robot based on the absolute position value of the autonomous mobile robot, and the current position value of the autonomous mobile robot is acquired by at least one second sensor.

According to a second aspect of the embodiment to achieve the above or another objects, the position correction method of an autonomous mobile robot autonomously driving in an indoor area of a building includes: receiving relative position information of an autonomous mobile robot acquired by each of a plurality of first sensors; acquiring an absolute position value of the autonomous mobile robot based on relative position information of the autonomous mobile robot; and correcting the current position value of the autonomous mobile robot acquired by the at least one second sensor based on the absolute position value of the autonomous mobile robot. The building includes a plurality of first sensors installed in the indoor area, and the autonomous mobile robot includes at least one second sensor.

According to a third aspect of the embodiment to achieve the above or another objects, a cloud device that communicates with a plurality of autonomous mobile robots autonomously driving in an indoor area of a building includes: a communicator; and a processor. The processor receives relative position information of a specific autonomous mobile robot among the plurality of autonomous mobile robots that are autonomously driving through the communicator, and the relative position information of the specific autonomous mobile robot is acquired by each of the plurality of first sensors, and acquire the absolute position value of the specific autonomous mobile robot based on the relative position information of the specific autonomous mobile robot, and transmit the absolute position value of the specific autonomous mobile robot to the specific autonomous mobile robot through the communicator to correct the current position value of the autonomous mobile robot, and the current position value of the specific autonomous mobile robot is acquired by the at least one second sensor. The building includes a plurality of first sensors installed in the indoor area, and the autonomous mobile robot includes at least one second sensor.

According to a fourth aspect of the embodiment to achieve the above or another objects, the position correction method of the cloud device communicating with a plurality of autonomous mobile robots autonomously driving in an indoor area of a building includes: based on each of the plurality of first sensors, receiving relative position information of a specific autonomous mobile robot among the plurality of autonomous mobile robots that are autonomously driving; obtaining an absolute position value of the specific autonomous mobile robot based on relative position information of the specific autonomous mobile robot; and transmitting the absolute position value of the specific autonomous mobile robot to the specific autonomous mobile robot to correct the current position value of the specific autonomous mobile robot obtained by the at least one second sensor. The building includes a plurality of first sensors installed in the indoor area, and the autonomous mobile robot includes at least one second sensor.

### Advantageous Effects

The effects of the autonomous mobile robot, cloud device, and position correction method according to the embodiment are explained as follows.

Whether the current position value obtained by at least one second sensor provided in the autonomous mobile robot is accurate using a plurality of first sensors installed in an external space away from the autonomous mobile robot, for example, an indoor area of a building. If the current position value is incorrect, that is, if a position error occurs, the accuracy and precision of autonomous driving can be improved by correcting the current position value to minimize or eliminate the position error.

Additional scope of applicability of the embodiments will become apparent from the detailed description below. However, since various changes and modifications within the spirit and scope of the embodiments may be clearly understood by those skilled in the art, the detailed description and specific embodiments, such as preferred embodiments, should be understood as being given by way of example only.

### DESCRIPTION OF DRAWINGS

FIG. 1 shows an AI device including a robot according to an embodiment of the present disclosure.

FIG. 2 shows an AI server connected to a robot according to an embodiment of the present disclosure.

FIG. 3 shows an AI system including a robot according to an embodiment of the present disclosure.

FIG. 4 is a perspective view of a robot according to an embodiment of the present disclosure.

FIG. 5 is a block diagram showing the control configuration of a robot according to an embodiment of the present disclosure.

FIG. 6 shows an autonomous driving system according to the first embodiment.

FIG. 7 is a plan view showing a plurality of first sensors installed in a building.

FIG. 8 shows how to obtain an absolute position using a plurality of relative position information.

FIG. 9 is a sequence diagram explaining the position correction method of the autonomous driving system according to the first embodiment.

FIG. 10 is a flowchart showing S430 in FIG. 9 in detail.

FIG. 11 is a flowchart showing S4220 of FIG. 10 in detail.

FIG. 12 shows the difference between the absolute position value and the current position value.

FIG. 13 shows an autonomous driving system according to the second embodiment.

FIG. 14 is a sequence diagram explaining the position correction method of the autonomous driving system according to the second embodiment.

FIG. 15 is a flowchart showing S540 in FIG. 14 in detail.

### MODE FOR INVENTION

Hereinafter, embodiments disclosed in the present specification will be described in detail with reference to the attached drawings, but identical or similar components will be assigned the same reference numbers regardless of the reference numerals, and duplicate descriptions thereof will be omitted. The suffixes ‘module’ and ‘part’ for components used in the following description are given or used interchangeably in consideration of ease of specification preparation, and do not have distinct meanings or roles in themselves. In addition, the attached drawings are intended to facilitate easy understanding of the embodiments disclosed in this specification, and the technical ideas disclosed in this specification are not limited by the attached drawings. Additionally, when an element such as a layer, region or substrate is referred to as being ‘on’ another component, this includes either directly on the other element or there may be other intermediate elements in between.

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

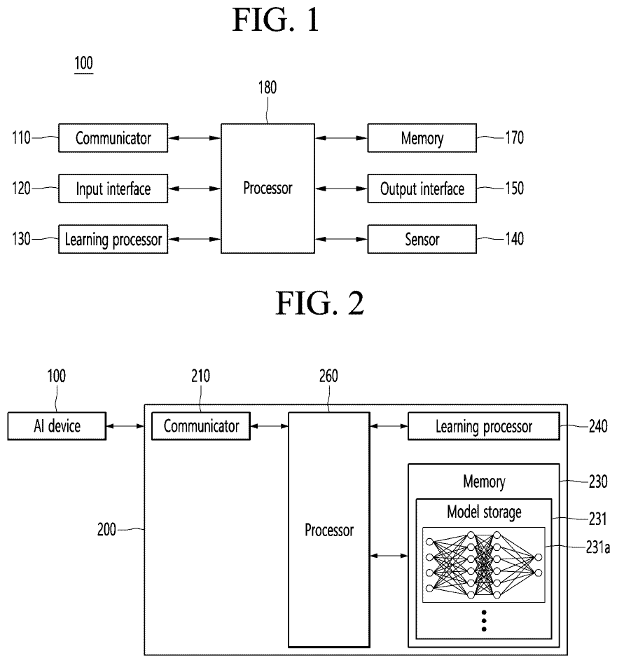

FIG. 1 illustrates an AI device including a robot according to an embodiment of the present disclosure.

The AI device 10 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 10 may include a communicator 110, an input interface 120, a learning processor 130, a sensor 140, an output interface 150, a memory 170, and a processor 180.

The communicator 110 may transmit and receive data to and from external devices such as other AI devices 100a to 100e and the AI server 200 by using wire/wireless communication technology. For example, the communicator 110 may transmit and receive sensor information, a user input, a learning model, and a control signal to and from external devices.

The communication technology used by the communicator 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

At this time, the input interface 120 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 120 may acquire a learning data for model learning and an input data to be used when an output is acquired by using learning model. The input interface 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensor 140 may acquire at least one of internal information about the AI device 100, ambient environment information about the AI device 100, and user information by using various sensors.

Examples of the sensors included in the sensor 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar. Here, the lidar may be a 3D TOF (Time Of Flight) sensor, but is not limited thereto.

The output interface 150 may generate an output related to a visual sense, an auditory sense, or a haptic sense.

At this time, the output interface 150 may include a display unit for outputting time information, a speaker for outputting auditory information, and a haptic module for outputting haptic information.

The memory 170 may store data that supports various functions of the AI device 100. For example, the memory 170 may store input data acquired by the input interface 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 connected to a robot according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communicator 210, a memory 230, a learning processor 240, a processor 260, and the like.

The communicator 210 can transmit and receive data to and from an external device such as the AI device 100.

The memory 230 may include a model storage 231. The model storage 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

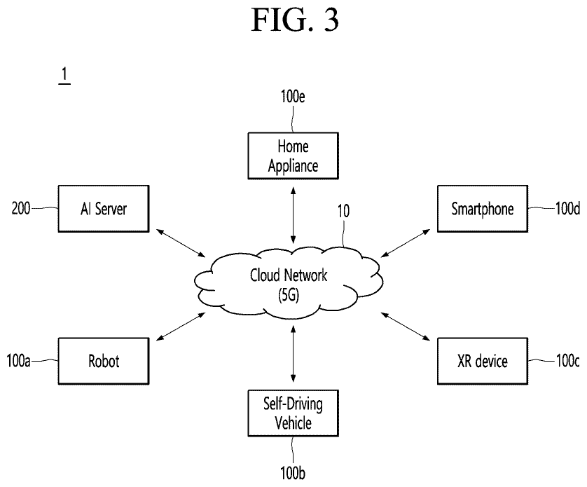

FIG. 3 illustrates an AI system according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 2. The robot 100a, the self-driving vehicle 100b, the XR device 100c, the smartphone 100d, or the home appliance 100e, to which the AI technology is applied, may be referred to as AI devices 100a to 100e.

At least one of the robot 100a, the self-driving vehicle 100b, the XR device 100c, the smartphone 100d, or the home appliance 100e may be the AI device 100 shown in FIG. 1.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

### Example of Robot Perspective View

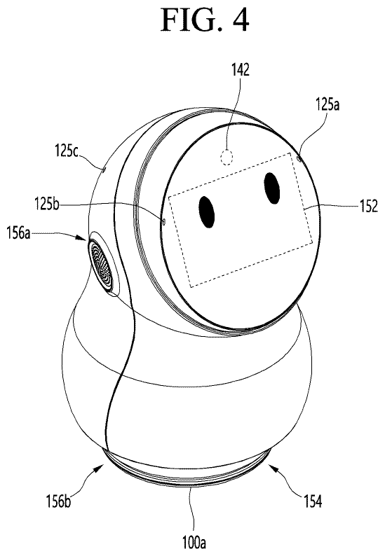

FIG. 4 is a perspective view illustrating a robot according to the present embodiment.

Referring to FIG. 4, the robot 100a may correspond to a communication robot that performs actions such as providing information or content to a user or inducing a specific action through communication or interaction with the user.

For example, the robot 100a may be an autonomous home robot placed in an indoor area of a building. These autonomous home robots can perform actions such as providing various information or content to users through interaction with users, or monitoring events that occur within the home.

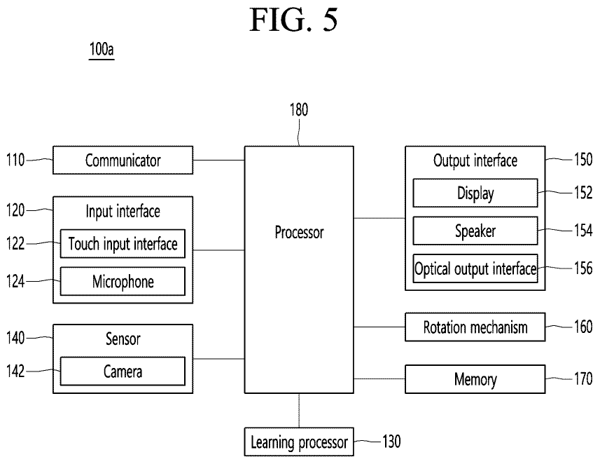

In order to perform the above-described operation, the robot 100a may include input/output means such as a camera 142 that acquires images around the user or the robot, at least one microphone 124 (see FIG. 5) that acquires the user's voice or sounds around the robot, a display 152 that outputs graphics or text, a sound output interface 154 (e.g., a speaker) that outputs voice or sound, and an optical output interface (156; see FIG. 5) that outputs light in a color or pattern mapped to a specific event or situation.

The robot 100a has at least one microphone hole 125a to 125c formed on the outer surface of the cover (or case) in order to smoothly acquire sound from outside the robot through at least one microphone 124 implemented inside. Each of the microphone holes 125a to 125c is formed at a position corresponding to one microphone 124, and the microphone 124 may communicate with the outside through the microphone holes 125a to 125c. Meanwhile, the robot 100a may include a plurality of microphones arranged to be spaced apart from each other. In this case, the robot 100a may detect the direction from which the sound originates using the plurality of microphones.

The display 152 may be arranged to face one side from the robot 100a. Hereinafter, the direction in which the display 152 faces is defined as the front of the robot 100a. Meanwhile, the sound output interface 154 is shown as being placed at the bottom of the robot 100a, but the location of the sound output interface 154 may vary depending on the embodiment.

The light output interface 156 is implemented as a light source such as an LED, and can indicate the status or events of the robot 100a through changes in color or output pattern. In FIG. 4, the first optical output interface 156a disposed on both sides of the robot 100a and the second optical output interface 156b disposed at the lower part of the robot 100a are shown. However, the number and arrangement positions of the optical output interface 156 can be changed in various ways.

Although not shown, the robot 100a may further include a moving means (traveling means) for moving from one location to another. For example, the moving means may include at least one wheel and a motor that rotates the wheel.

### <Robot Control Configuration>

FIG. 5 is a block diagram showing the control configuration of a robot according to an embodiment of the present disclosure.

Referring to FIG. 5, the robot 100a may include a communicator 110, an input interface 120, a learning processor 130, a sensor 140, an output interface 150, a rotation mechanism 160, and a memory 170, and processor 180. The configurations shown in FIG. 4 are examples for convenience of explanation, and the robot 100a may include more or fewer configurations than the configurations shown in FIG. 4.

Meanwhile, since the content related to the AI device 100 in FIG. 1 is similarly applied to the robot 100a of the present disclosure, content overlapping with the content described above in FIG. 1 will be omitted.

The communicator 110 may include communication modules for connecting the robot 100a to a server, mobile terminal, other robot, etc. through a network. Each of the communication modules may support any one of the communication technologies described above in FIG. 1.

For example, the robot 100a may be connected to the network through an access point such as a router. Accordingly, the robot 100a can provide various information acquired through the input interface 120 or the sensor 140 to a server or mobile terminal through the network. Additionally, the robot 100a can receive information, data, commands, etc. from the server or mobile terminal.

The input interface 120 may include at least one input means for acquiring various types of data. For example, the at least one input means may include a physical input means such as a button or dial, a touch input interface 122 such as a touch pad or touch panel, and a microphone 124 that receives the user's voice or sounds around the robot 100a. The user can input various requests or commands to the robot 100a through the input interface 120.

The sensor 140 may include at least one sensor that senses various information around the robot 100a. For example, the sensor 140 may include various sensors such as a camera 142, a proximity sensor, an illumination sensor, a touch sensor, and a gyroscope.

The camera 142 may acquire images around the robot 100a. Depending on the embodiment, the processor 180 may recognize the user by acquiring an image including the user's face through the camera 142, or acquire the user's gestures or facial expressions.

The proximity sensor can detect that an object such as a user approaches the robot 100a. For example, when a user's approach is detected by a proximity sensor, the processor 180 may output an initial screen or an initial voice through the output interface 150 to induce the user to use the robot 100a.

The illuminance sensor can detect the brightness of the space where the robot 100a is placed. The processor 180 may control components to perform various operations based on the detection result of the illuminance sensor and/or time zone information.

The touch sensor may detect that a part of the user's body is in contact with a predetermined area of the robot 100a.

The gyro sensor can detect the rotation angle or tilt of the robot 100a. The processor 180 may recognize the direction in which the robot 100a is heading or may detect an impact from the outside based on the detection result of the gyro sensor.

The output interface 150 may output various information or content related to the operation or status of the robot 100a, various services, programs, and applications running on the robot 100a. Additionally, the output interface 150 can output various messages or information for interaction with the user.

The output interface 150 may include a display 152, a speaker 154, and an optical output interface 156.

The display 152 can output the various information, messages, or contents described above in graphic form. Depending on the embodiment, the display 152 may be implemented in the form of a touch screen together with the touch input interface 122, and in this case, the display 152 may function not only as an output means but also as an input means.

The speaker 154 can output the various information, messages, or contents in the form of voice or sound.

The light output interface 156 may be implemented as a light source such as LED. The processor 180 may indicate the status of the robot 100a through the optical output interface 156. Depending on the embodiment, the optical output interface 156 may provide various information to the user together with the display 152 and/or the speaker 154 as an auxiliary output means.

The rotation mechanism 160 may include a first motor for rotating the robot 100a about a vertical axis. The processor 180 controls the first motor included in the rotation mechanism 160 to rotate the robot 100a, thereby changing the directions of the display 152 and the camera 142 of the robot 100a to the left and right.

Depending on the embodiment, the rotation mechanism 160 may further include a second motor for tilting the robot 100a at a predetermined angle in the front-back direction. The processor 180 controls the second motor to tilt the robot 100a, thereby changing the direction in which the display 152 and the camera 142 face upward and downward.

The memory 170 may store various data such as control data for controlling the operations of components included in the robot 100a, and data for performing actions based on input obtained through the input interface 120 or information acquired through the sensor 140.

Additionally, the memory 170 may store program data such as software modules or applications executed by at least one processor or controller included in the processor 180.

In terms of hardware, this memory 170 may include various storage devices such as ROM, RAM, EPROM, flash drive, hard drive, etc.

The processor 180 may include at least one processor or controller that controls the operation of the robot 100a. Specifically, the processor 180 may include at least one CPU, an application processor (AP), a microcomputer (or microcomputer), an integrated circuit, an application specific integrated circuit (ASIC), etc.

### First Embodiment

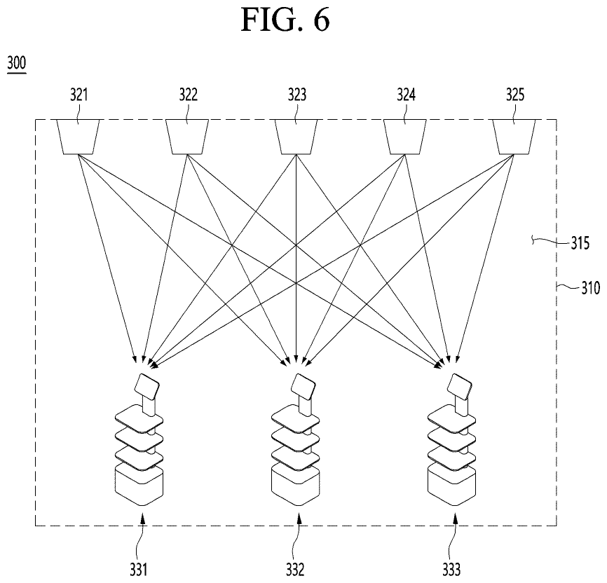

FIG. 6 shows an autonomous driving system according to the first embodiment.

Referring to FIG. 6, the autonomous driving system 300 according to the first embodiment may include a plurality of autonomous mobile robots (331 to 333) and a plurality of first sensors (321 to 325).

The autonomous driving system 300 according to the first embodiment may be a system that autonomously drives or manages a plurality of autonomous mobile robots (331 to 333). The plurality of autonomous mobile robots 331 to 333 may be the AI device 100 shown in FIG. 1, the robot 100a shown in FIG. 3, or the autonomous vehicle 100b.

Each of a plurality of autonomous mobile robots (331 to 333) creates a map image in advance using at least one second sensor such as LiDAR or a camera, and performs autonomous driving is implemented by estimating the location on a map image using sensor data measured at the time of autonomous driving. The current position value of the autonomous mobile robot (331 to 333) that is driving autonomously may be obtained using at least one second sensor. Here, the second sensor may be the sensor 140 shown in FIG. 5.

However, as described above, the autonomous mobile robot only drives autonomously believing that its current position value is accurate, and it is unknown whether the current position value is accurate. Additionally, in reality, position errors occur in the current position recognized by the autonomous mobile robot due to various environments or malfunctions of various sensors provided in the autonomous mobile robot during autonomous driving. However, since the autonomous mobile robot does not know whether the current position value is accurate, it cannot know whether a position error has occurred in the current position value. Here, position error may mean the difference between the current position value of the autonomous mobile robot and the actual exact current position value of the autonomous mobile robot.

Therefore, it is determined whether the current position value obtained by at least one second sensor provided in each autonomous mobile robot is an accurate position value and whether there is a position error in the current position value And, according to the result of determination, a method or device that can correct the current position value to minimize or eliminate the position error is urgently needed.

In contrast, the autonomous driving system 300 according to the first embodiment may be implemented in the indoor area 315 of the building 310. For example, the autonomous driving system 300 according to the first embodiment may be implemented at home, or in public places such as workplaces or airports. For example, an autonomous mobile robot may be a delivery robot, but is not limited thereto.

According to an embodiment, using a plurality of first sensors (321 to 325) installed in an external space, for example the indoor area (315) of the building (310), spaced apart from the autonomous mobile robot (331 to 333), it is determined whether the current position value obtained by at least one second sensor provided in the mobile robot (331 to 333) is accurate. If the current position value is incorrect, that is, if a position error occurs, the accuracy and precision of autonomous driving can be improved by correcting the current position value to minimize or eliminate the position error. A detailed explanation of this will be provided later.

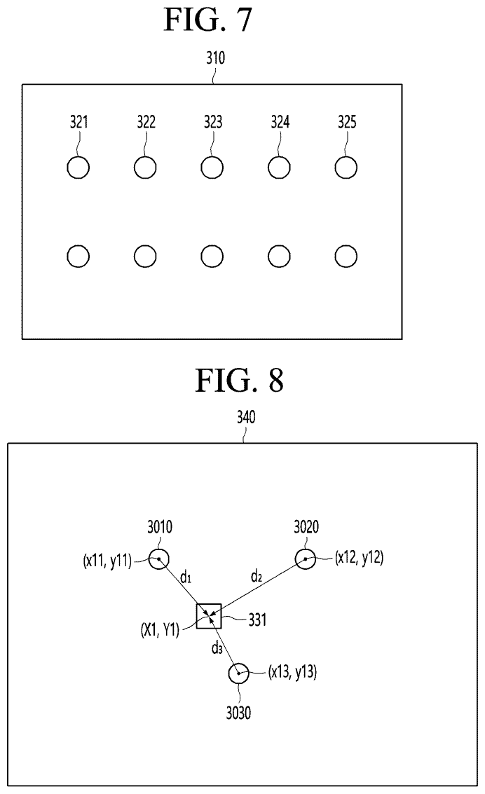

As shown in FIG. 7, a plurality of first sensors 321 to 325 may be installed in the indoor area 315 of the building 310. In FIG. 7, the plurality of first sensors 321 to 325 are shown to be spaced apart from each other while maintaining the same distance, but they may be installed to have different distances from each other.

The first sensors 321 to 325 may be lidar, for example, a 3D TOF sensor, but this is not limited.

For example, the plurality of first sensors 321 to 325 may be installed above the indoor area 315, that is, on the ceiling of the building 310, but this is not limited. Sensing (or measurement) ranges sensed or measured by the plurality of first sensors 321 to 325 may overlap with each other.

When each of the plurality of autonomous mobile robots 331 to 333 is autonomously driving, each of the plurality of first sensors 321 to 325 can obtain relative position information of each of the plurality of autonomous mobile robots 331 to 333. The relative position information of each of the plurality of autonomous mobile robots 331 to 333 obtained from each of the plurality of first sensors 321 to 325 may be transmitted to each of the plurality of autonomous mobile robots 331 to 333.

Although not shown, a hub may be provided that can collect the relative position information of each of the plurality of autonomous mobile robots 331 to 333 obtained from each of the plurality of first sensors 321 to 325 and then transmit to each of the plurality of autonomous mobile robots 331 to 333.

For example, the hub receives relative position information of each of the plurality of autonomous mobile robots 331 to 333 from each of the plurality of first sensors 321 to 325, and then transmit the received relative position information of each of the plurality of autonomous mobile robots 331 to 333 to the plurality of autonomous mobile robots 331 to 333.

The relative position information may include identification information for each of a plurality of autonomous mobile robots 331 to 333. Identification information for each of the plurality of autonomous mobile robots 331 to 333 is set in the hub, or the hub communicates with the plurality of autonomous mobile robots 331 to 333 to be provided identification information for each of the plurality of autonomous mobile robots 331 to 333.

For example, the relative position information may include information related to a distance value between the first sensor 321 to 325 and the corresponding autonomous mobile robot 331 to 333 and direction from the first sensors 321 to 325 to the corresponding autonomous robots 331 to 333.

As shown in FIG. 8, coordinate values ((x11, y11), (x12, y12), and (x13, y13)) of each of the plurality of first sensors 321 to 325 are mapped on map image 340 and set on the map image 340. Therefore, an absolute position values (X1, Y1) of each of the corresponding autonomous robots 331 to 333 can be obtained by using distance values (d1, d2, d3) for each of the corresponding autonomous robots 331 to 333 obtained from each of the plurality of first sensors 321 to 325 and coordinate values ((x11, y11), (x12, y12) and (x13, y13)) of each of the plurality of first sensors 321 to 325. The absolute position value (X1, Y1) is the actual position value of each autonomous mobile robot 331 to 333 that is driving autonomously, and the absolute position value (X1, Y1) is the exact position value of each autonomous mobile robot 331 to 333.

Relative position information, that is, distance values (d1, d2, d3) and direction information, may be obtained from each of the sensor 3010, the 1-2 sensor 3020, and the 1-3 sensor 3030. As described above, the first coordinate values (x11, y11) of the 1-1 sensor 3010, the second coordinate values (x12, y12) of the 1-2 sensor 3020, and the third coordinate values (x13, y13) of the 1-3 sensor 3030 may be set on the map image 340.

The position corresponding to a corresponding distance value (d1, d2, d3) included in the direction information from each of the first coordinate values (x11, y11) of the 1-1 sensor 3010, the second coordinate values (x12, y12) of the 1-2 sensor 3020, and the third coordinate values of the 1-3 sensor 3030 can be defined as an absolute position value (or absolute coordinate value) (X1, Y1).

In this case, a first absolute coordinate value of a position spaced apart by the first distance value (d1) in the first direction from the first coordinate value (x11, y11) of the 1-1 sensor 3010, a second absolute coordinate value of a position spaced apart by the second distance value (d2) in the second direction from the second coordinate value (x12, y12) of the 1-2 sensor 3020, and a third coordinate value of a position spaced apart by the third distance value (d3) in the third direction from the third coordinate value (x13, y13) of the 1-3 sensor 3030 may be the same as the absolute position value (X1, Y1). Therefore, the first coordinate values (x11, y11) of the 1-1 sensor 3010, the second coordinate values (x12, y12) of the 1-2 sensor 3020, third coordinate values (x13, y13) of the 1-3 sensor 3030 and the absolute position value (X1, Y1), which is the actual exact position value of each of the autonomous mobile robot 331 to 333 that are autonomously driving based on the direction information of the relative position information, can be easily obtained.

Meanwhile, each of the plurality of autonomous mobile robots 331 to 333 can correct the current position value of each autonomous mobile robot 331 to 333 based on the absolute position value. The current position value of each autonomous mobile robot 331 to 333 may be acquired by at least one second sensor provided in each of the autonomous mobile robots 331 to 333.

As an example, as shown in FIG. 8, each of a plurality of autonomous mobile robots 331 to 333 corrects the current position value (X2, Y2) of the autonomous mobile robot 331 to 333 into an absolute position value (X1, Y1). For example, as shown in FIG. 12, the current position value (X2, Y2) may be corrected (or updated) to the absolute position value (X1, Y1), so that the current position becomes (X1, Y1). Accordingly, each of the autonomous mobile robots 331 to 333 can autonomously drive to a desired destination or perform a desired operation at the desired destination based on the corrected current location (X1, Y1). For example, correction of the current position values (X2, Y2) of each autonomous mobile robot 331 to 333 may be performed periodically. For example, correction of the current position value (X2, Y2) of each autonomous mobile robot 331 to 333 may be performed in units of 5 minutes, 30 minutes, 1 hour, or 5 hours, but this is not limited.

As another example, as shown in FIG. 8, each of the plurality of autonomous mobile robots 331 to 333 may correct the current position value (X2, Y2) of each autonomous mobile robot 331 to 333 by using the absolute position value (X1, Y1) of the autonomous mobile robot 331 to 333 and the current position value (X2, Y2) of each of the autonomous mobile robot 331 to 333. For example, each of the plurality of autonomous mobile robots 331 to 333 may correct the current position value (X2, Y2) of each autonomous mobile robot 331 to 333 based on the difference value between the absolute position value (X1, Y1) of each autonomous mobile robot 331 to 333 and the current position value (X2, Y2) of each autonomous mobile robot 331 to 333. The difference between the absolute position values (X1, Y1) of each of the autonomous mobile robot 331 to 333 and the current position values (X2, Y2) of each of the autonomous mobile robot 331 to 333 may be referred to as a position error.

As shown in FIG. 12, the difference between the absolute position value (X1, Y1) and the current position value (X2, Y2) may be the position error (Δ).

For example, position error (A) can be expressed as Equation 1.

$$Δ D = \vert X 1 - X 2 \vert + \vert Y 1 - Y 2 \vert \qquad [ Equation 1 ]$$

In other words, as shown in Equation 1, position error (Δ) may be the sum of the absolute value of the difference between the X coordinate value (X1) of absolute position value (X1, Y1) and the X coordinate value (X2) of current position value (X2, Y2) and the absolute value of the difference between the Y coordinate value (Y1) of the absolute position value (X1, Y1) and the Y coordinate value (Y2) of the current position value (X2, Y2). Equation 1 is just an example, and there may be various ways to calculate the position error (Δ).

Specifically, each of the plurality of autonomous mobile robots 331 to 333 may compare the difference value (A) between the absolute position value (X1, Y1) of each autonomous mobile robot 331 to 333 and the current position value (X2, Y2) of each autonomous mobile robot 331 to 333 with the threshold value, and correct the current position value (X2, Y2) of each autonomous mobile robot 331 to 333 to the absolute position value (X1, Y1) of each autonomous mobile robot 331 to 333 if the difference value (A) exceeds the threshold value.

The threshold value may be a reference value for determining whether to make corrections or not. If the threshold value is small, corrections may be performed frequently, which may place a burden on the computation of each processor (180 in FIG. 5) of the autonomous mobile robots 331 to 333. If the threshold value is big, compensation is not performed frequently, reducing the computational burden, but since each autonomous mobile robot 331 to 333 drives autonomously with a certain degree of position error (Δ), the accuracy and precision of autonomous driving is not guaranteed. Therefore, appropriate threshold value must be set, and this threshold value can be set using optimization methods or artificial intelligence.

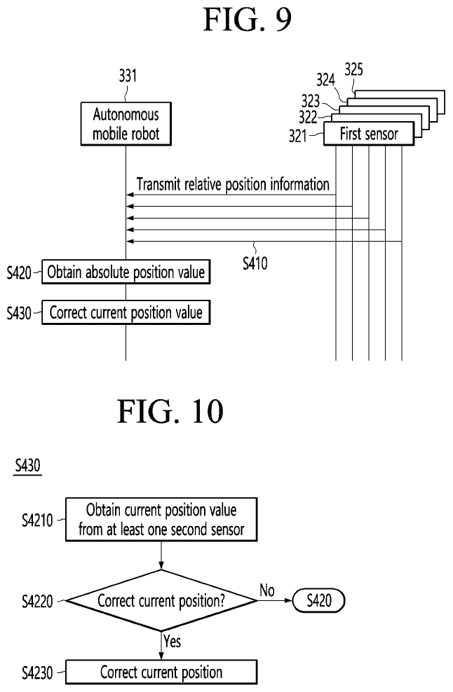

FIG. 9 is a sequence diagram explaining the position correction method of the autonomous driving system according to the first embodiment. Although the first autonomous mobile robot 331 is shown in FIG. 9, the remaining autonomous mobile robots 332 and 333 can also use the same position correction method of the autonomous driving system of FIG. 9.

Referring to FIGS. 6 and 9, relative position information of the first autonomous mobile robot 331 is obtained from each of the plurality of first sensors 321 to 325 installed in the indoor area 315 of the building 310. Relative position information may include distance value and direction information. The distance value is the distance between the plurality of first sensors 321 to 325 and the first autonomous mobile robot 331 currently driving autonomously, and the direction information includes a vector direction component to the first autonomous mobile robot 331 from each of the plurality of first sensors 321 to 325.

Each of the plurality of first sensors 321 to 325 may transmit the obtained relative position information to the first autonomous mobile robot 331 (S410). Since relative position information is acquired by each of the plurality of first sensors 321 to 325, there may be a plurality of relative position information.

The first autonomous mobile robot 331 may receive the obtained relative position information through the communicator (110 in FIG. 5).

The first autonomous mobile robot 331, that is, the processor (180 in FIG. 5) may obtain the absolute position value of the first autonomous mobile robot 331 based on the relative position information of the first autonomous mobile robot 331 corresponding to each of the plurality of first sensors 321 to 325 (S420). The first autonomous mobile robot 331 can correct the current position value using the absolute position value (S430).

As shown in FIGS. 8 and 12, the absolute position value (X1, Y1) can be obtained based on the relative position information, which is obtained from the coordinate values ((x11, y11), (x12, y12), (x13, y13)) of each of the plurality of first sensors 3010, 3020, 3030 and each of the plurality of first sensors 3010, 3020, 3030, that is the distance values (d1, d2, d3) and direction information.

The first autonomous mobile robot 331 may correct the current position value (X2, Y2) of the first autonomous mobile robot 331 based on the absolute position value (X1, Y1) of the first autonomous mobile robot.

As shown in FIG. 12, the current position value (X2, Y2) of the first autonomous mobile robot 331 acquired by at least one second sensor can be mapped on the map image 340. In this case, the absolute position value (X1, Y1) mapped on the map image 340 and the current position value (X2, Y2) may not match. This may mean that a position error (Δ) occurs. The degree to which the absolute position value (X1, Y1) and the current position value (X2, Y2) do not match each other is the size of the position error, which can be expressed as A. As shown in Equation 1, position error (Δ) may be the difference value (Δ) between the absolute position value (X1, Y1) and the current position value (X2, Y2). The bigger the difference value (Δ), the bigger the position error (Δ).

As shown in FIG. 10, the first autonomous mobile robot 331 can obtain its current position value from at least one second sensor (S4210).

The first autonomous mobile robot 331 can determine whether to correct the current position based on the absolute position value of the first autonomous mobile robot 331 (S4220). If the first autonomous mobile robot 331 determines to correct the current location, it can correct the current location (S4230).

Whether or not to correct may be determined without considering the threshold value or by considering the threshold value.

As an example, as shown in FIG. 8, when the threshold value is not considered, the first autonomous mobile robot 331 can correct the current position value (X2, Y2) to the absolute position value (X1, Y1) of the first autonomous mobile robot 331 if the absolute position value (X1, Y1) and current position value (X2, Y2) are mismatch, that is, a position error (Δ), which is the difference value (Δ) between the absolute position value (X1, Y1) and the current position value (X2, Y2) occurs. In this case, because the threshold value is not considered, the current position value (X2, Y2) is corrected whenever a position error (Δ) occurs, which may act as a computational burden on the first autonomous mobile robot 331. To solve this problem, correction of the current position value (X2, Y2) is performed intermittently or periodically, so that the computational burden on the first autonomous mobile robot 331 can be reduced.

As another example, as shown in FIG. 8, correction of the current position value (X2, Y2) may be performed by considering the threshold value.

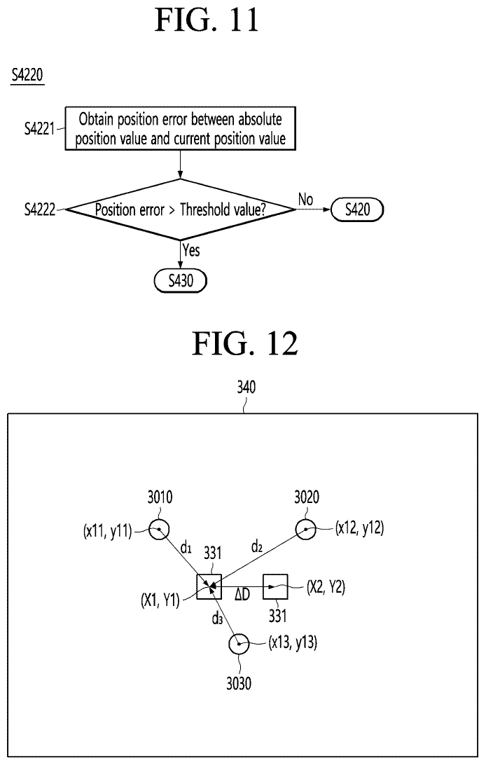

That is, as shown in FIG. 11, when considering the threshold value, the first autonomous mobile robot 331 can obtain the difference value between the absolute position value (X1, Y1) and the current position value (X2, Y2), that is, the position error (Δ) (S4221). The absolute position value (X1, Y1) and current position value (X2, Y2) can be obtained for the first autonomous mobile robot 331. The absolute position value (X1, Y1) is obtained by each of the plurality of first sensors 321 to 325 installed in the indoor area 315 of the building 310, and the current position value (X2, Y2) is obtained by at least one second sensor provided in the first autonomous mobile robot 331. The difference value (Δ) may be the position error (Δ) shown in Equation 1.

The first autonomous mobile robot 331 compares the position error (Δ) between the absolute position value (X1, Y1) and the current position value (X2, Y2) with the threshold value (S4222), correct the current position value (X2, Y2) to the absolute position value (X1, Y1) if the position error (Δ) is greater than the threshold value.

### Second Embodiment

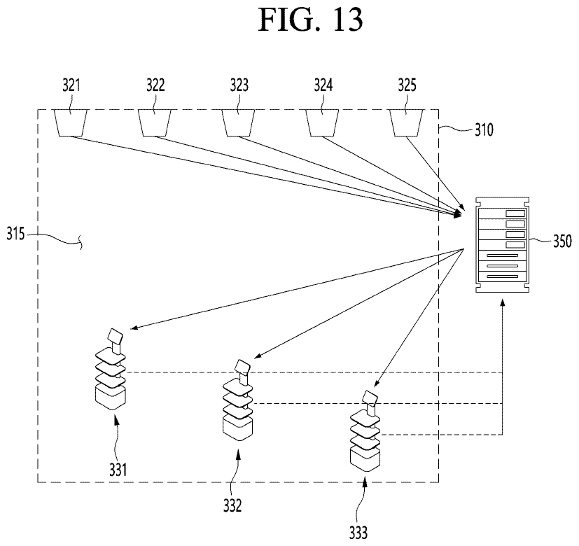

FIG. 13 shows an autonomous driving system according to the second embodiment.

The second embodiment is the same as the first embodiment except for the cloud device 350. That is, while the absolute position value is obtained from each of the autonomous mobile robots 331 to 333 in the first embodiment, it can be obtained from the cloud device 350 in the second embodiment. Accordingly, in the first embodiment, while the relative position information of each of the autonomous mobile robots 331 to 333 obtained from each of the plurality of first sensors 321 to 325 installed in the indoor area 315 of the building 310 is provided to the each of the autonomous mobile robots 331 to 333, in the second embodiment, it may be provided to the cloud device 350.

In the second embodiment, components having the same functions as those in the first embodiment are given the same reference numerals and detailed descriptions are omitted.

Referring to FIG. 13, the autonomous driving system 300A according to the second embodiment includes a plurality of autonomous mobile robots 331 to 333, a plurality of first sensors 321 to 325, and a cloud device 350.

The cloud device 350 may be called a cloud server, cloud network, network server, network device, etc. At least one cloud device 350 may be provided. The cloud device 350 may communicate individually or collectively with the plurality of autonomous mobile robots 331 to 333 to manage and/or control each of the plurality of autonomous mobile robots 331 to 333. In other words, the cloud device 350 transmits and receives information or data with each of the plurality of autonomous mobile robots 331 to 333 and transmits commands or control signals to each of the plurality of autonomous mobile robots 331 to 333, each of the robots 331 to 333 may perform a corresponding operation or take action according to the corresponding command or control signal.

A plurality of first sensors 321 to 325 may be installed in the indoor area 315 of the building 310. For example, the plurality of the first sensors 321 to 325 may be installed on the ceiling of the building 310, but this is not limited. Each of the plurality of first sensors 321 to 325 may obtain relative position information of each of the plurality of autonomous mobile robots 331 to 333, and transmit each of the obtained relative position information to the cloud device 350.

Although not shown, a hub may be provided that is capable of collecting the relative position information of each of the plurality of autonomous mobile robots 331 to 333 obtained from each of the plurality of first sensors 321 to 325 and then transmitting it to the cloud device 350. Since the hub has been described above, detailed description will be omitted.

Each of the plurality of autonomous mobile robots 331 to 333 may be capable of autonomous driving in the indoor area 315 of the building 310. Each of the plurality of autonomous mobile robots 331 to 333 is capable of avoiding dangerous obstacles on its own, searching for a safe path (or passage), and autonomously driving along that path.

When each of the plurality of autonomous mobile robots 331 to 333 drives autonomously, each of the plurality of autonomous mobile robots 331 to 333 acquires its current position value, and transmits the obtained current position value to the cloud device 350. The current position value may be obtained by at least one second sensor installed in each of the plurality of autonomous mobile robots 331 to 333.

The cloud device 350 may receive relative position information of each of the plurality of autonomous mobile robots 331 to 333 obtained by each of the plurality of first sensors 321 to 325 through the communicator (210 in FIG. 2) and the current position information of each of the plurality of autonomous mobile robots 331 to 333 obtained by at least one second sensor installed in each of the plurality of autonomous mobile robots 331 to 333. For example, the current position information may include the current position value of each of a plurality of autonomous mobile robots 331 to 333.

The cloud device 350 can obtain the absolute position value of each of the plurality of autonomous mobile robots 331 to 333 based on relative position information corresponding to each of the plurality of first sensors 321 to 325 for each of the plurality of autonomous mobile robots 331 to 333. As described above, as shown in FIG. 8, the absolute position value (X1, Y1) can be obtained from the relative position information corresponding to the coordinate value ((x11, y11), (x12, y12), (x13, y13)) of the plurality of first sensors 3010 to 3030 and each of the plurality of first sensors 3010 to 3030, that is distance values (d1, d2, d3) and direction information.

The cloud device 350 may transmit the absolute position value (X1, Y1) of each of the plurality of autonomous mobile robots 331 to 333 to each of the plurality of autonomous mobile robots 331 to 333.

Each of the plurality of autonomous mobile robots 331 to 333 may receive the absolute position value (X1, Y1) of each of the plurality of autonomous mobile robots 331 to 333 through the communicator (110 in FIG. 5). Each of the plurality of autonomous mobile robots 331 to 333 may correct the current position value (X2, Y2) based on the absolute position value (X1, Y1) of each of the plurality of autonomous mobile robots 331 to 333.

As an example, each of a plurality of autonomous mobile robots 331 to 333 may correct the current position value (X2, Y2) to the absolute position value (X1, Y1) if a position error (Δ) occurs. That is, the current position value (X2, Y2) can be changed (or updated) to the absolute position value (X1, Y1). Here, position error (Δ) is the difference value (Δ) between the absolute position value (X1, Y1) and the current position value (X2, Y2), and can be expressed in Equation 1. At this time, correction of the current position value (X2, Y2) may be performed intermittently or periodically.

As another example, each of the plurality of autonomous mobile robots 331 to 333 does not immediately correct the current position value (X2, Y2) even if a position error (Δ) occurs. That is, whether to correct the current position value (X2, Y2) can be determined by considering the threshold value. For example, if the position error (Δ) is greater than the threshold value, the current position value (X2, Y2) can be corrected to the absolute position value (X1, Y1).

That is, each of the plurality of autonomous mobile robots 331 to 333 can compare the position error (Δ) and the threshold value, and determine whether to correct the current position value (X2, Y2) according to the comparison result. For example, if the position error (Δ) is greater than the threshold value, the current position value (X2, Y2) can be corrected to the absolute position value (X1, Y1). For example, if the position error (Δ) is equal to or smaller than the threshold value, the current position value (X2, Y2) may not be corrected and is maintained.

According to an embodiment, it is determined whether the current position value (X2, Y2) obtained by at least one second sensor provided in each of the autonomous mobile robots 331 to 333 is accurate by using the plurality of first sensors 321 to 325 installed in an external space spaced apart from each of the autonomous mobile robots 331 to 333, for example, an indoor area 315 of a building 310. If the current position value (X2, Y2) is not accurate, that is, if a position error (Δ) occurs, the current position value (X2, Y2) is corrected to minimize or eliminate the position error (Δ), thereby the accuracy and precision of autonomous driving can be improved.

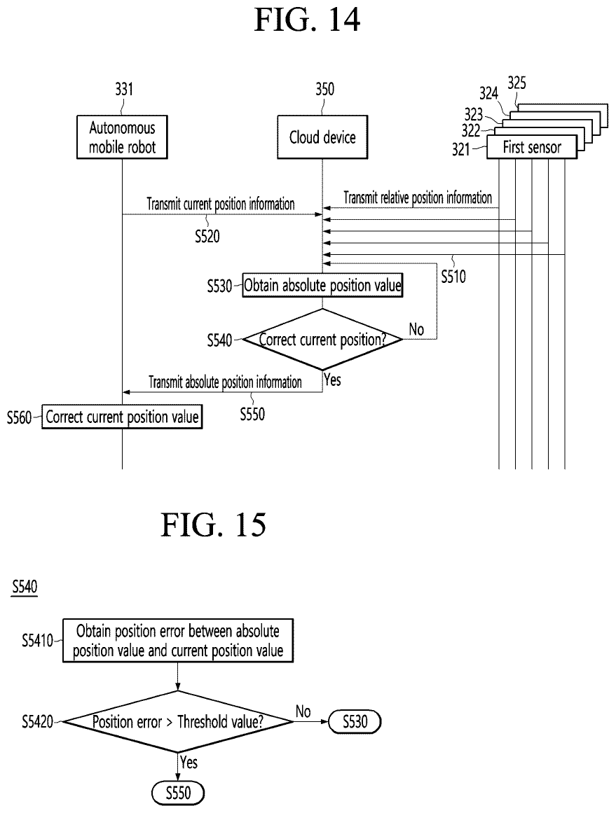

FIG. 14 is a sequence diagram explaining the position correction method of the autonomous driving system according to the second embodiment. Although the first autonomous mobile robot 331 is shown in FIG. 14, the remaining autonomous mobile robots 332 and 333 can also use the same position correction method of the autonomous driving system of FIG. 14.

Referring to FIGS. 13 and 14, relative position information of the first autonomous mobile robot 331 is obtained from each of the plurality of first sensors 321 to 325 installed in the indoor area 315 of the building 310. The relative position of the first autonomous mobile robot 331 obtained by each of the plurality of first sensors 321 to 325 may be transmitted to the cloud device 350 (S510). Relative position information may include distance value and direction information. The distance value is the distance between the plurality of first sensors 321 to 325 and the first autonomous mobile robot 331 currently driving autonomously, and the direction information can include a vector direction component from each of the plurality of the first sensor 321 to 325 to the first autonomous mobile robot 331.

The first autonomous mobile robot 331 transmits the current position information of the first autonomous mobile robot 331 obtained by at least one second sensor installed on the first autonomous mobile robot 331 to a cloud device 350 (S520). For example, the current position information may include the current position value of the first autonomous mobile robot 331.

The order of the transmitting step (S510) of the relative position information of the first autonomous mobile robot 331 and the transmission step (S520) of the current position value of the first autonomous mobile robot 331 can be changed temporally.

The cloud device 350 may receive the relative position information of the first autonomous mobile robot 331 obtained by each of the plurality of first sensors 321 to 325 through a communicator (210 in FIG. 2), and receive the current position information of the first autonomous mobile robot 331 obtained by at least one second sensor installed in the first autonomous mobile robot 331.

The cloud device 350 may obtain the absolute position value of the first autonomous mobile robot 331 based on the coordinate values of each of the plurality of first sensors 321 to 325 and the relative position information, obtained by each of the plurality of first sensors 321 to 325, that is, distance value and direction information (S530).

The cloud device 350 may determine whether to correct the current location (S540). If the cloud device 350 determines to correct the current location, it can transmit absolute location information to the first autonomous mobile robot 331 (S550). The first autonomous mobile robot 331 can correct the current position value using the absolute position information (S560).

As an example, as shown in FIG. 8, when the threshold value is not considered, the cloud device 350 transmits the absolute position information of the first autonomous mobile robot 331 to the first autonomous mobile robot 331 if a position error (Δ) occurs. The absolute position information may include absolute position value (X1, Y1). Position error (Δ) may be the difference value (Δ) between the absolute position value (X1, Y1) and the current position value (X2, Y2), as shown in Equation 1. The first autonomous mobile robot 331 can correct (change or update) the current position value (X2, Y2) to the absolute position value (X1, Y1).

As another example, as shown in FIG. 8, when considering the threshold value, as shown in FIG. 15, the cloud device 350 can acquire the difference value (Δ) between the absolute position value (X1, Y1) and the current position value (X2, Y2) (S5410). If the difference value (Δ) exists, a position error (Δ) has occurred, and if the difference value (Δ) does not exist, the position error (Δ) did not occur. The cloud device 350 may compare the difference value (Δ) or position error (Δ) with the threshold value (S5420), and determine whether to correct the current position value (X2, Y2) according to the comparison result. For example, if the position error (Δ) is greater than the threshold value, the current position value (X2, Y2) can be corrected to the absolute position value (X1, Y1). For example, if the position error (Δ) is equal to or smaller than the threshold value, or is less than the threshold value, the current position value (X2, Y2) may be maintained as is without correction.

The above detailed description should not be construed as restrictive in any respect and should be considered illustrative. The scope of the embodiments should be determined by reasonable interpretation of the appended claims, and all changes within the equivalent scope of the embodiments are included in the scope of the embodiments.

### INDUSTRIAL APPLICABILITY

The embodiment can be applied to a mobile object that can move. Moving objects can be collectively referred to as mobility. A robot is only one type of moving object, and embodiments can be applied to a wide variety of moving objects. Robots may have artificial intelligence capabilities or be capable of autonomous driving.

1. An autonomous mobile robot capable of driving autonomously in an indoor area of a building, wherein the building comprises a plurality of first sensors installed in the indoor area, the autonomous mobile robot comprising:
a communicator;
at least one second sensor; and
a processor configured to:
receive, through the communicator, relative position information of the autonomous mobile robot while the autonomous mobile robot is autonomously driving, wherein the relative position information of the autonomous mobile robot is acquired from each of the plurality of first sensors,
acquire an absolute position value of the autonomous mobile robot based on the relative position information of the autonomous mobile robot,
correct a current position value of the autonomous mobile robot based on the absolute position value, wherein the current position value of the autonomous mobile robot is acquired by the at least one second sensor.

2. The autonomous mobile robot according to claim 1, wherein the processor is configured to periodically correct the current position value of the autonomous mobile robot with respect to periodic updates to the absolute position value of the autonomous mobile robot.

3. The autonomous mobile robot according to claim 1, wherein the processor is configured to correct the current position value of the autonomous mobile robot based on a position error between the absolute position value of the autonomous mobile robot and the current position value of the autonomous mobile robot.

4. The autonomous mobile robot according to claim 3, wherein the processor is configured to;
compare the position error to a threshold value, and
correct the current position value of the autonomous mobile robot to the absolute position value of the autonomous mobile robot if-based on the position error is-being greater than the threshold value.

5. A position correction method performed by an autonomous mobile robot capable of driving autonomously in an indoor area of a building, wherein the building comprises a plurality of first sensors installed in the indoor area and the autonomous mobile robot comprises at least one second sensor, the position correction method comprising:
receiving relative position information of the autonomous mobile robot while the autonomous mobile robot is autonomously driving, wherein the relative position information of the autonomous mobile robot is acquired from each of the plurality of first sensors;
obtaining an absolute position value of the autonomous mobile robot based on the relative position information of the autonomous mobile robot; and
correcting a current position value of the autonomous mobile robot based on the absolute position value, wherein the current position value of the autonomous mobile robot is acquired by the at least one second sensor.

6. The position correction method according to claim 5, wherein the correcting comprises:
periodically correcting the current position value of the autonomous mobile robot with respect to periodic updates to the absolute position value of the autonomous mobile robot.

7. The position correction method according to claim 5, wherein the correcting comprises:
correcting the current position value of the autonomous mobile robot based on a position error between the absolute position value of the autonomous mobile robot and the current position value of the autonomous mobile robot.

8. The position correction method according to claim 7, wherein the correcting based on the position error comprises:
comparing the position error with a threshold value; and,
correcting the current position value of the autonomous mobile robot to the absolute position value of the autonomous mobile robot based on the position error being greater than the threshold value.

9. A cloud device that communicates with a plurality of autonomous mobile robots driving autonomously in an indoor area of a building, wherein the building comprises a plurality of first sensors installed in the indoor area, wherein each of the plurality of autonomous mobile robots comprises at least one second sensor, the cloud device comprising:
a communicator; and
a processor configured to:
receive, through the communicator, relative position information of a specific autonomous mobile robot of the plurality of autonomous mobile robots while the specific autonomous mobile robot is autonomously driving, wherein the relative position information of the specific autonomous mobile robot is acquired by each of the plurality of first sensors,
determine an absolute position value of the specific autonomous mobile robot based on the relative position information of the specific autonomous mobile robot,
transmit the absolute position value of the specific autonomous mobile robot to the specific autonomous mobile robot through the communicator to correct the current position value of the specific autonomous mobile robot, wherein the current position value of the specific autonomous mobile robot is acquired by the at least one second sensor of the specific autonomous mobile robot.

10. The cloud device according to claim 9, wherein the processor is configured to periodically correct the current position value of the autonomous mobile robot with respect to periodic updates to the absolute position value of the specific autonomous mobile robot.

11. The cloud device according to claim 9, wherein the processor is configured to:
receive the current position value of the specific autonomous mobile robot through the communicator while the specific autonomous mobile robot is autonomously driving,
correct the current position value of the specific autonomous mobile robot with respect to the absolute position value of the specific autonomous mobile robot based on a position error between the absolute position value of the specific autonomous mobile robot and the current position value of the specific autonomous mobile robot.

12. The cloud device according to claim 11, wherein the processor is configured to:
compare the position error with a threshold value,
correct the current position value of the specific autonomous mobile robot to the absolute position value of the specific autonomous mobile robot based on the position error being greater than the threshold value.

13. A position correction method performed by a cloud device capable of communicating with a plurality of autonomous mobile robots driving autonomously in an indoor area of a building, wherein the building comprises a plurality of first sensors installed in the indoor area, wherein each of the plurality of autonomous mobile robots comprises at least one second sensor, the position correction method comprising:
receiving, through the communicator, relative position information of a specific autonomous mobile robot of the plurality of autonomous mobile robots while the specific autonomous mobile robot is autonomously driving;
determining an absolute position value of the specific autonomous mobile robot based on the relative position information of the specific autonomous mobile robot; and
transmitting the absolute position value of the specific autonomous mobile robot to the specific autonomous mobile robot to correct the current position value of the specific autonomous mobile robot, wherein the current position value of the specific autonomous mobile robot is acquired by at least one second sensor of the specific autonomous mobile robot.

14. The position correction method according to claim 13, further comprising periodically correcting the current position value of the specific autonomous mobile robot with respect to periodic updates to the absolute position value of the specific autonomous mobile robot.

15. The position correction method according to claim 13, further comprising:
receiving the current position value of the specific autonomous mobile robot through the communicator; and
correcting the current position value of the specific autonomous mobile robot based on a position error between the absolute position value of the specific autonomous mobile robot and the current position value of the specific autonomous mobile robot.

16. The position correction method according to claim 15, wherein the correcting comprises:
comparing the position error with a threshold value; and;
correcting the current position value of the specific autonomous mobile robot with respect to the absolute position value of the specific autonomous mobile robot based on the position error being greater than the threshold value.
